(19) United States
(12) Patent Application Publication
(10) Pub. No.: US 2008/0282140 A1
(43) Pub. Date: Nov. 13, 2008

(54) EMBEDDED WEBSITE BANNER SYSTEM AND METHOD

(76) Inventor: Dimitry Ioffe, Los Angeles, CA (US)

Correspondence Address: PERKINS COIE LLP, P.O. BOX 1208, SEATTLE, WA, 98111-1208, US

(21) Appl. No.: 12/018,134

(22) Filed: Jan. 22, 2008

Related U.S. Application Data
(60) Provisional application No. 60/917,595, filed on May 11, 2007.

(51) Int. Cl. G06F 17/00

(52) U.S. Cl. 715/205

(57) ABSTRACT

A system and method for providing a website involve a novel way of porting a full website through an ad banner. A user viewing a website including the ad banner interacts with the ad banner. The ad banner then expands and the ported website is viewed in the expanded ad banner as covering over the first website. The user's perception does not include the experience of being redirected to another website. The method and system for providing this website are described herein.

### RELATED APPLICATIONS

This Application claims priority to U.S. Provisional Patent Application No. 60/917,595, filed Mar. 11, 2007 entitled “Embedded Website Banner System and Method” by Dimitry Ioffe, which is incorporated herein by reference.

### BACKGROUND

Websites often advertise. This is regularly done by the use of a link or graphic on the website which redirects a user to another website generally communicating services or products. Two main forms of this kind of advertising are known.

In the first, a graphic is displayed attracting the user to the products or services. This is generally known as an ad banner. The graphic is generally known as an ad banner. The graphic may invite the user to click on the graphic. Upon clicking the banner the user is re-directed to another site.

In the second, a rich media ad provides content. A rich media ad is often brightly colored and provides a variety of graphics to attract viewers. Content may be provided through the rich media ad, such as by linking the advertisement from a server different from the server providing the web page.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods that are meant to be exemplary and illustrative, not limiting in scope. In various embodiments, one or more of the above described problems have been reduced or eliminated, while other embodiments are directed to other improvements.

Providing a website may be accomplished according to a variety of methods. Porting a website through another website is a method involving a web browser including a website which has an ad banner. An interaction on the embedded website banner causes the embedded website banner to expand to centrally dominate the web browser in response to the interaction. The expanded ad banner may be moved to a point commanding attention. The website on which the embedded website banner was located is at least partially covered by the expanded banner. The ported website is then viewable through the expanded embedded website banner.

A system for accomplishing these objectives may include a computer, one or more information management systems, and a network. The computer provides a web browser, and the information management system provides a first and a second website. A user controls the computer interacting with the website and having her attention directed to the second website when it dominates the web browser and/or a monitor. Alternatively, there are two information management systems and a first provides a first website and an embedded website banner, and a second provides a second website which is ported through the embedded website banner.

In the case that a ported website has an animated menu, the animated menu can be directly interacted with via a variety of user input devices, where interactions with the animated menu may cause video, text or graphical content to display. The menu may be increased and decreased in size.

### BRIEF DESCRIPTION OF THE DRAWINGS

Embodiments of the inventions are illustrated in the figures. However, the embodiments and figures are illustrative rather than limiting; they provide examples of the inventions.

FIG. 1 depicts an example of an expanded embedded website banner porting a website through to cover another website.

FIG. 2 depicts a flow chart of examples of methods for providing a website.

FIG. 3 depicts an example of an embedded website banner expanding to port a website through to cover another website.

FIG. 4 depicts an example of interaction with a ported website using an animated menu.

FIG. 5 depicts a second example of interaction with a ported website using an animated menu.

FIG. 6 depicts an example of a system for interacting with a website: a computer with a keyboard and mouse.

FIG. 7 depicts an example of an information management system providing a website to a user.

FIG. 8 is a screenshot of a website having an embedded website banner advertising “Pirates of the Caribbean at Worlds End.”

FIG. 9 is a screenshot of a website having an embedded website banner which has expanded to port the website for “Pirates of the Caribbean at Worlds End” through to a user.

### DETAILED DESCRIPTION

In the following description, several specific details are presented to provide a thorough understanding of embodiments of the invention. One skilled in the relevant art will recognize, however, that the invention can be practiced without one or more of the specific details or in combination with other components, etc. In other instances, well-known implementations or operations are not shown or described in detail to avoid obscuring aspects of various embodiments of the invention.

When viewing a website, advertisements are placed on the website often times redirecting the user to another website via links. Advantageously, an embedded website banner can be placed on top of another website, expanded, and another website can be ported through the expanded embedded website banner. The user experiences continuity, not having been redirected to another site. This allows all content of the second site to be directed to the users attention while avoiding experiencing a redirection to another website.

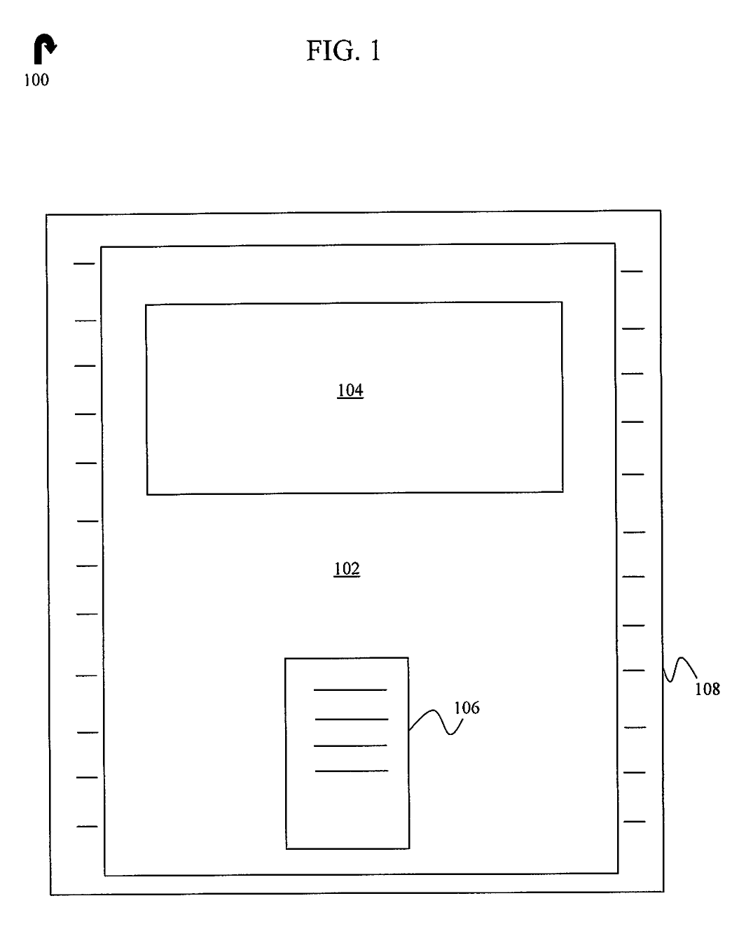

FIG. 1 depicts an example of a ported website system 100. The ported website system 100 includes an expanded embedded website banner 102, a video 104, a menu 106, and a website 108.

In the example of FIG. 1, the website 108 is covered in part by the expanded embedded website banner 102. A video 104, and an animated menu 106, both part of a website which may be unrelated to website 108, are commanding attention in the place of website 108.

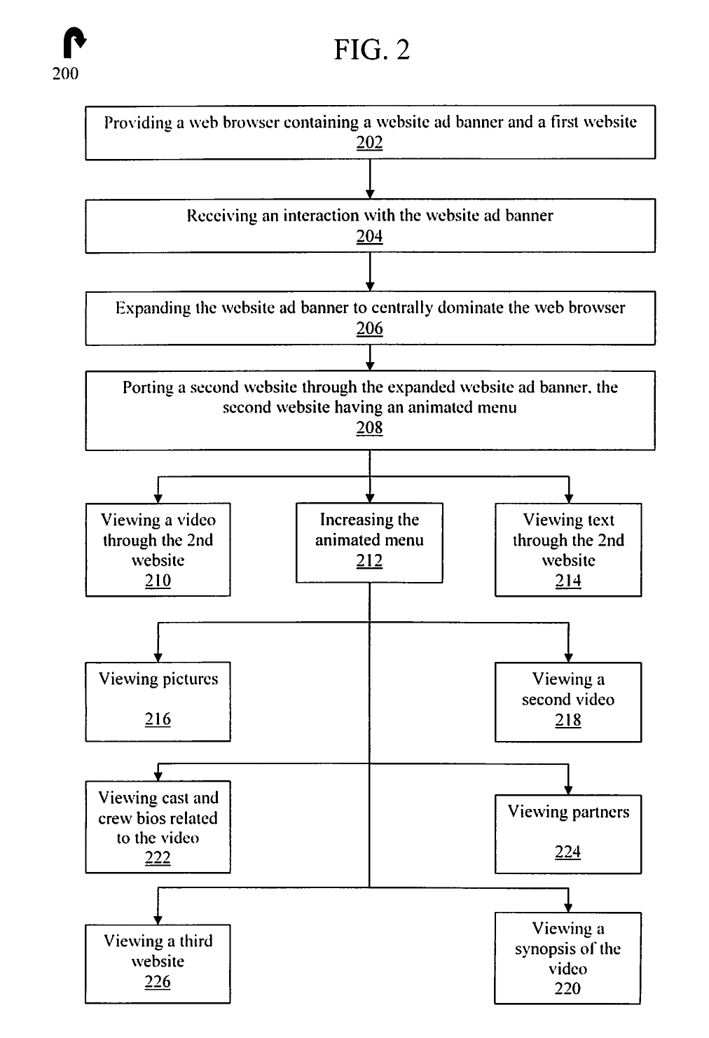

FIG. 2 depicts a flowchart 200 of an example of a method for providing a website. The method is organized as a sequence of modules in the flowchart 200. However, it should be understood that these and modules associated with other methods described herein may be reordered for parallel execution or into different sequences of modules.

In the example of FIG. 2 the flowchart 200 starts at module 202 providing a web browser including an embedded website banner and a first website. The website displays the embedded website banner, and other content as part of the website.

In the example of FIG. 2 at module 204, a user interacts with the embedded website banner. This interaction could be any rolling over, clicking, right clicking, left clicking, third mouse button clicking, wheel mouse button clicking, wheel mouse scrolling, and keyboard key depress. The embedded website banner will respond to this interaction.

In the example of FIG. 2 at module 206, the embedded website banner expands to centrally dominate the web browser. This position and coverage of the web browser commands attention. In a related non-limiting manner, the expanding could be accomplished via a flash object embedded in a website. Alternatively, a table of images in a second website could be created from images of the first website and a flash object centered creating the appearance that the website portal covers the first website and that the user has not been transferred off of the website. It is understood that these are exemplary only, and that a person skilled in the art could create the effect described herein in a variety of manners.

In the example of FIG. 2 at module 208, the second website is ported through the expanded embedded website banner. The content of the second website is made available through the first website. It is not necessary that the web server providing the first website also provide the second website. It is entirely possible that a separate web server provide the content for the first website and another server provide the content for the second website. The user's perception is the focus and one skilled in the relevant art would implement the appropriate technology to provide the effect of porting a second website through to a user using a first website. In module 210 the second website has a video which is viewed through the first website. In module 214 the second website has text which is viewed through the first website.

In the example of FIG. 2 at modules 210-226, additional content is made available to the user of the second website ported through the embedded website banner. In module 216 pictures are made available. In module 218, a second video is made available. In module 220, a synopsis of the video is made available. In module 222, the cast and crew biographies of the persons who created the video are made available. In module 224, partners of the entities which created the video are made available. In module 226, a third website is made available.

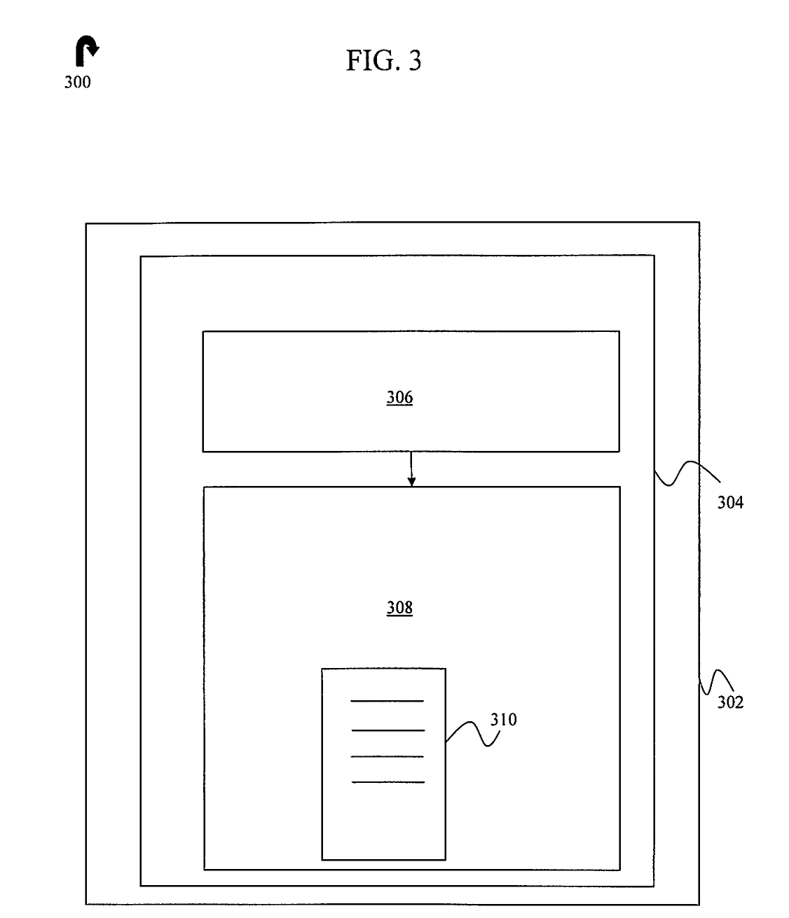

FIG. 3 depicts an example of an embedded website banner expanding to port a website through to cover another website. The system has monitor 302, website 304, embedded website banner 306, and expanded embedded website banner 308 porting a second website through including an animated menu 310.

In the example of FIG. 3 monitor 302 displays website 304, on which embedded website banner 306 resides. In response to a user interaction, embedded website banner 306 expands to become embedded website banner 308 porting a second website. The second website includes content including animated menu 310.

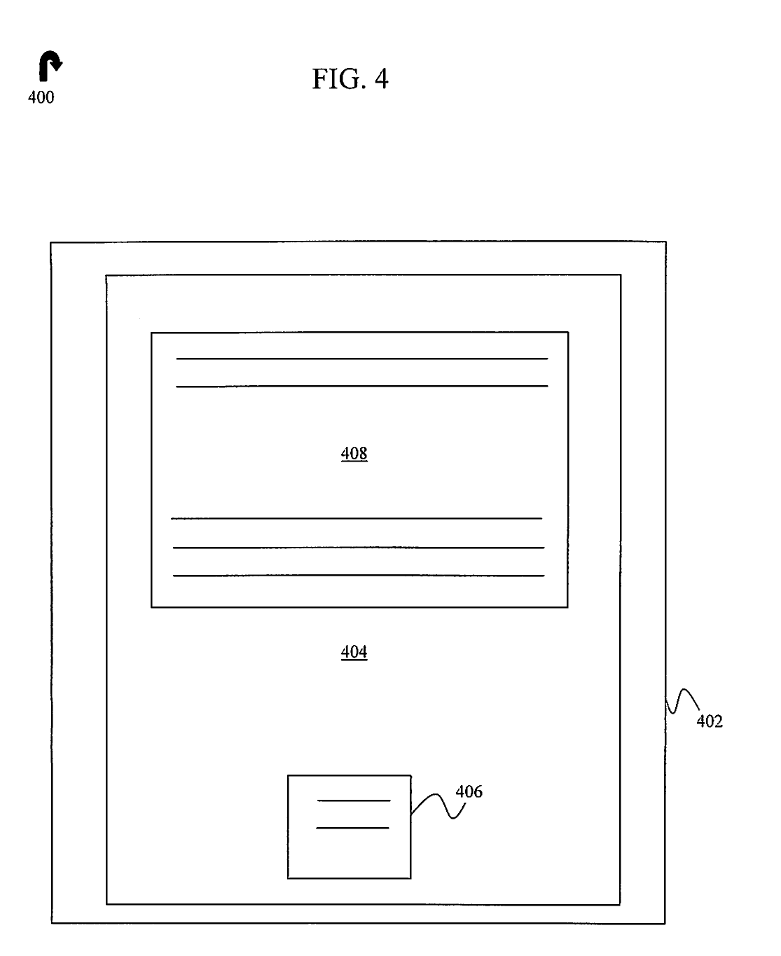

FIG. 4 depicts an example of interaction with a ported website using an animated menu. The system has website 402, expanded ad banner 404, animated menu 406, and text 408. In the example of FIG. 4 website 402 displays expanded ad banner 404. Through animated menu 406 an interaction is received causing text 408 to be displayed.

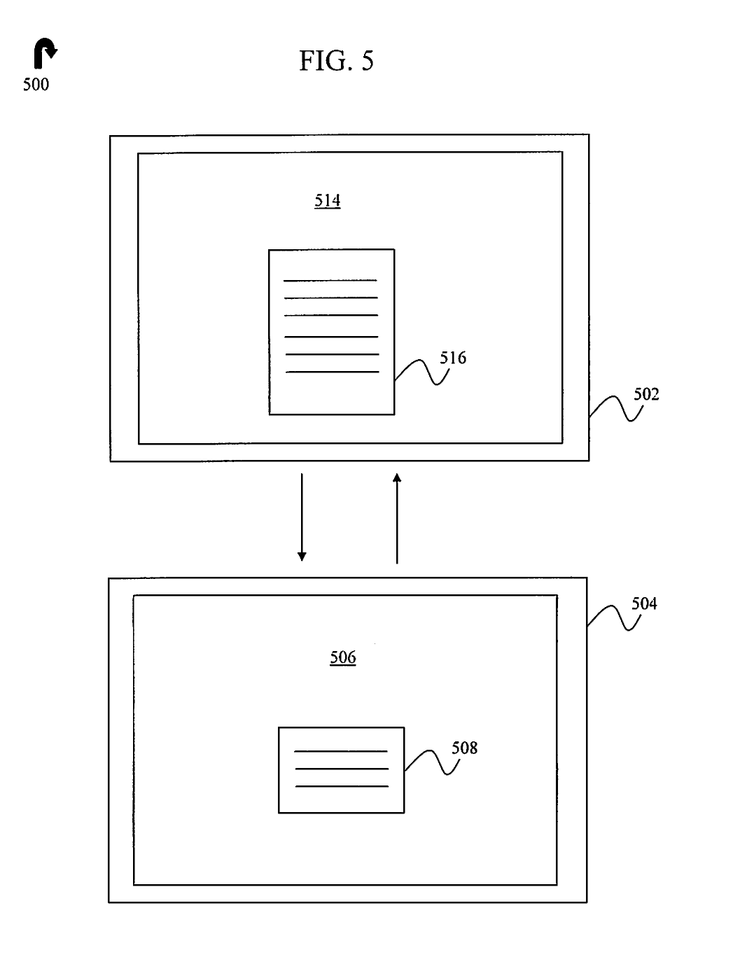

FIG. 5 depicts an example of website system 500. The system has a website at first state 502, the website at second state 504, an expanded ad banner at a first state 506 including a second website having an animated menu at a first state 508, the expanded ad banner at a second state 514, and the second website having the animated menu at a second state 516.

In the example of FIG. 5 a website at a first state 504 ported through the expanded ad banner at a first state 506 receives an interaction with the animated menu at a first state 508. In response to the interaction, the animated menu at a first state 508 increases in size to become the animated menu at a second state 516 located in the expanded ad banner.

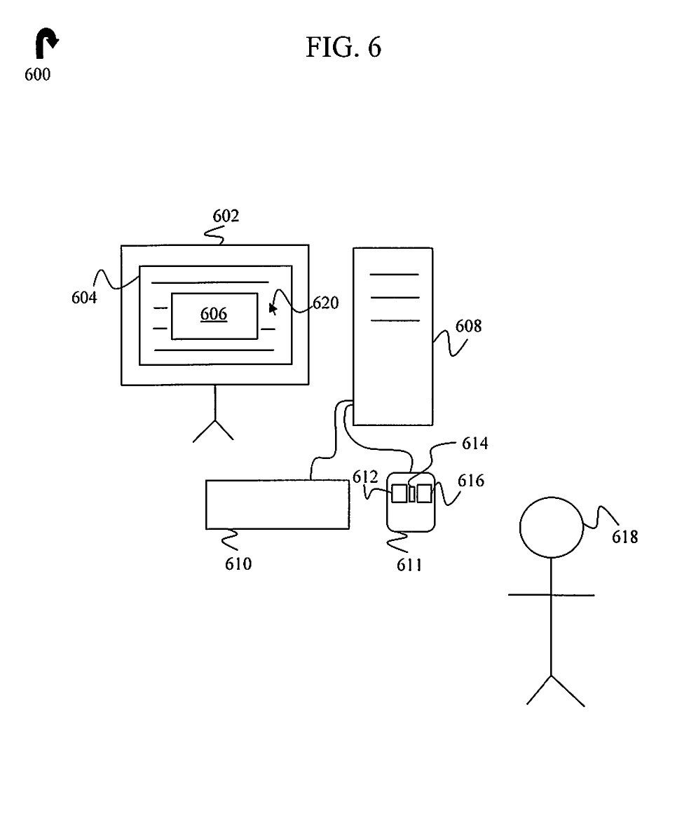

FIG. 6 depicts an example of a system 600 for interacting with a website: a computer with a keyboard and mouse. The system 600 includes a monitor 602, a web browser 604, a ported website 606, a computer 608, a keyboard 610, a mouse 611, a first button 612, a third button 614, a second button 616, a user 618, and a pointer 620.

In the example of FIG. 6, the user views monitor 602. Displayed on monitor 602, the user views the ported website 606 as covering over the website 604. The user interacts with the ported website 606 via input devices such as keyboard 610 and mouse 612. These interactions include rolling over, clicking, right clicking, left clicking, third mouse button clicking, wheel mouse button clicking, wheel mouse scrolling, and keyboard key depress. Any known or convenient manner of interacting with a computer may be implemented.

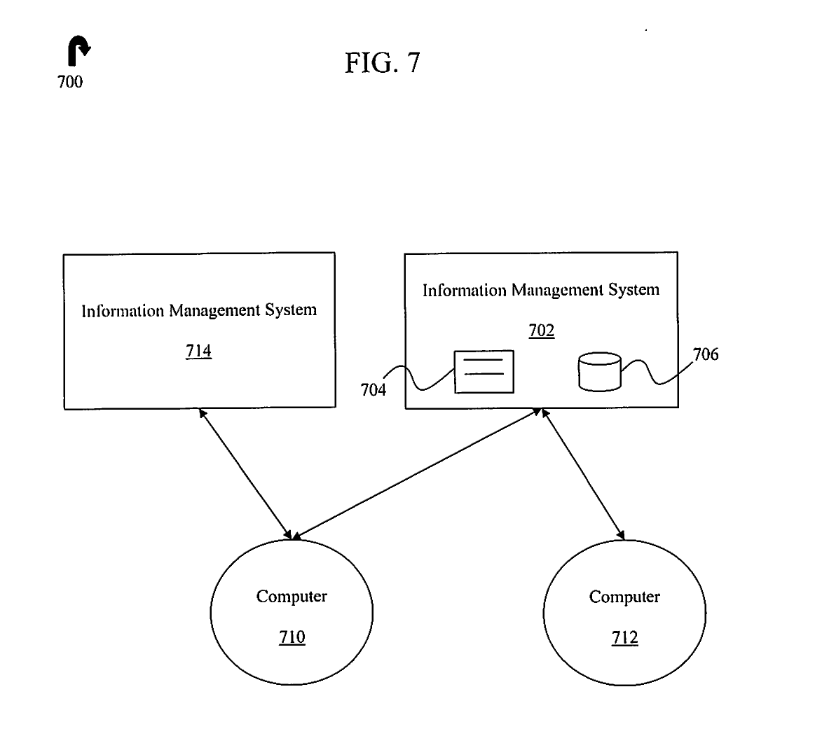

FIG. 7 depicts an example of an embedded website banner distribution system 700 providing a website to a user. Embedded website banner distribution system 700 includes information management system 702, server 704, database 706, computer 710, computer 712, and information management system 714.

In the example of FIG. 7, information management system 702 provides a website including an embedded website banner to computer 710. Information management system 714 then provides a second website to computer 710. The embedded website banner ports the second website to the computer 710. Additionally, computer 712 may or may not receive a first and a second, ported, website through information management system 702.

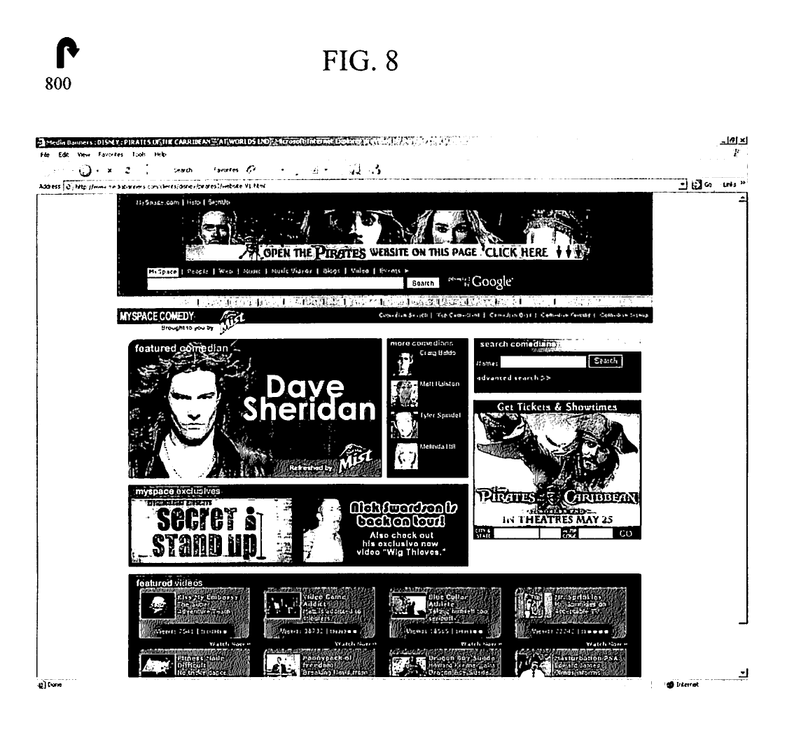

FIG. 8 is a screenshot 800 of a website having an embedded website banner advertising “Pirates of the Caribbean at Worlds End.” In the example of screenshot 800, the embedded website banner is not expanded, and invites a user to “open the Pirates website on this page click here” enticing a user to experience the Pirates website without leaving the current website.

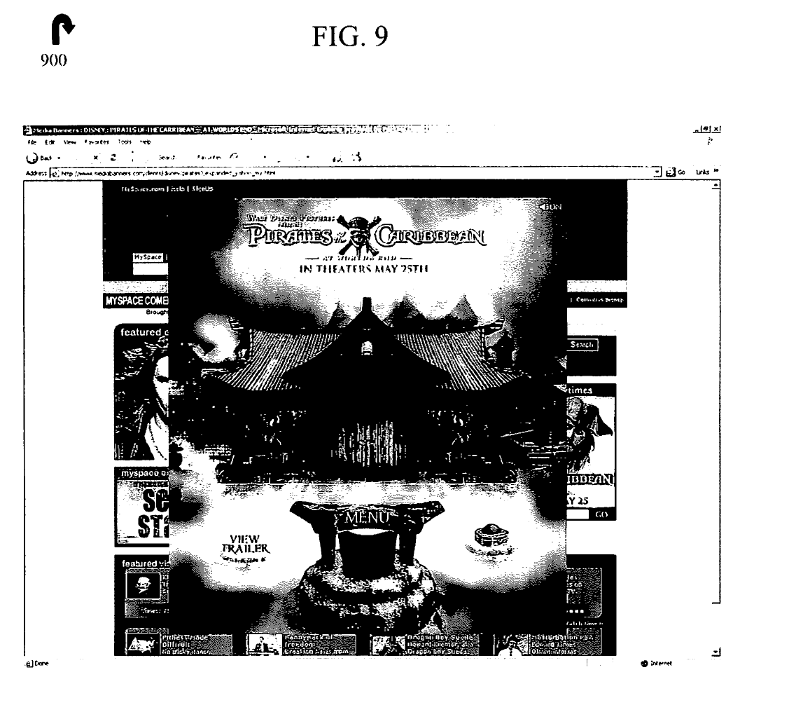

FIG. 9 is a screenshot 900 of a website having an embedded website banner which has expanded to port the website for “Pirates of the Caribbean at Worlds End” through to a user. In the example of FIG. 900 the ad banner has been fully expanded covering over the website which the ad banner was advertised on. The user is free to interact with the Pirates website having maintained the experience of continuity without delay.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

We claim:

1. A method of providing a website comprising:
providing a web browser including an embedded website banner and a first website;
receiving an interaction with the embedded website banner;
expanding the embedded website banner to centrally dominate the web browser in response to the interaction;
porting a second website through the expanded embedded website banner, the second website at least partially covering the first website.

2. The method of claim 1 wherein the center of the embedded website banner is moved from a non-central point of the web browser to a point commanding attention.

3. The method of claim 2 wherein the point commanding attention is the center of the web browser.

4. The method of claim 2 wherein the point commanding attention is the center of a monitor displaying the web browser.

5. The method of claim 1 wherein the second website has an animated menu.

6. The method of claim 5 wherein the animated menu receives a second interaction and causes a video to play in the second website in response to the second interaction.

7. The method of claim 5 wherein the animated menu decreases in size in response to a third interaction.

8. The method of claim 7 wherein the animated menu increases in size in response to a fourth interaction.

9. The method of claim 1 wherein the interaction is selected from the group consisting of rolling over, clicking, right clicking, left clicking, third mouse button clicking, wheel mouse button clicking, wheel mouse scrolling, and keyboard key depress.

10. A system providing a website comprising:
a web browser including an embedded website banner and a first website;
a computer having a monitor displaying the web browser, the embedded website banner and the first website;
a user input device connected to the computer;
a user interacting with the embedded website banner via the input device causing the embedded website banner to expand in size to centrally dominate the web browser;
a second website provided to the user through the expanded embedded website banner, the full second website covering the first website.

11. The system of claim 10 wherein the embedded website banner is moved from a non-central point of the web browser to a point commanding the user's attention.

12. The system of claim 10 wherein the point commanding attention of the user is the center of the web browser.
The system of claim 10 wherein the point commanding the user's attention is the center of the monitor displaying the website.

13. The system of claim 10 further comprising:
a second video, the second video plays in the second website in response to receiving a second interaction.

14. The system of claim 10 further comprising:
a menu displayed in the embedded website banner.

15. The system of claim 10 wherein the menu decreases in size in response to a third interaction between the user and the second website.

16. The system of claim 10 wherein the menu increases in size in response to a fourth interaction the user and the second website.

17. The system of claim 10 wherein the second website has:
a unit of text displayed for the user in the second website.

18. The system of claim 10 wherein the interaction is performed by the user and is selected from the group consisting of rolling over, clicking, right clicking, left clicking, third mouse button clicking, wheel mouse button clicking, wheel mouse scrolling, and keyboard key depress.

19. The system of claim 10 further comprising:
an information management system providing the embedded website banner to the computer via a network.

20. An embedded website banner embodied in a computer readable medium comprising:
an advertisement which when interacted with expands to cover the website it is advertised on and provides a second website through the expanded advertisement.

21. The embedded website banner embodied in a computer readable medium of claim 20 wherein the second website includes a menu.

22. The embedded website banner embodied in a computer readable medium of claim 20 wherein the second website includes additional information.
